(19) United States
(12) Patent Application Publication
(10) Pub. No.: US 2002/0134771 A1
(43) Pub. Date: Sep. 26, 2002

(54) Flame-retarded laser-markable polyester composition

(76) Inventors: Richard Wenger, Evansville, IN (US); Marnix Van Gurp, Sittard (NL); Eric J.H.E. Coenen, Berg en Terblijt (NL); William A.C. Roovers, Sittard (NL); Esther Wessels, Sittard (NL)

Correspondence Address: PILLSBURY WINTHROP, LLP, P.O. BOX 10500, MCLEAN, VA, 22102, US

(21) Appl. No.: 09/754,259

(22) Filed: Jan. 5, 2001

(51) Int. Cl. B23K 26/00; C09K 21/00; C08K 3/10; C08K 3/40

(52) U.S. Cl. 219/121.69; 252/609; 524/409; 524/494

(57) ABSTRACT

The invention relates to a flame-retarded polyester composition comprising 20-95 mass % aromatic polyester; 4-25 mass % bromine-containing flame-retardant compound; 1-12 mass % antimony oxide of average particle size 0.5-15 micron; and optionally polytetrafluoroethylene; glass fibers; and other additives. The composition shows a desirable combination of high strength and toughness, good melt-flow characteristics, no blooming and can be laser-marked with improved contrast. The invention also relates to a molded part for use in electrical or electronic applications, which part may be provided with a dark marking on a lighter background surface. The invention also relates to a process for applying a laser mark, as well as to an article carrying a dark laser mark on a light background surface for use in electrical or electronic applications.

### FIELD OF THE INVENTION

The invention relates to a flame-retarded laser-markable polyester composition comprising a bromine-containing flame-retardant compound and antimony oxide, which composition shows a desirable combination of high strength and toughness, good melt-flow characteristics, no blooming and which can be laser-marked with improved contrast. The invention also relates to a molded part for use in electrical or electronic applications, which part may be provided with a dark marking on a lighter background surface. The invention also relates to a process for applying a dark marking on a lighter background surface of an article at least partly made from a polyester composition, as well as to an article carrying a dark laser mark on a light background surface for use in electrical or electronic applications.

### BACKGROUND OF THE INVENTION

Thermoplastic polyester compositions are often used in applications that have flame-retardant properties as a critical requirement. Typical examples are electrical or electronic parts and components like housings, bobbins, switches and connectors. In many of these applications the polyester compositions should be classified as V-0 in the test according to Underwriters Laboratories Standard 94 (UL-94 test). Depending on the specific application the polyester composition should also fulfill various other requirements regarding mechanical and electrical properties. For use in connectors, which often are rather thin walled, the polyester composition should for example display high stiffness and strength and yet have enough toughness to enable e.g. snap-fit constructions, have good stability during molding and good melt flow behavior to ensure complete mold filling at short cycle times. After molding of a part no additives or degradation products should migrate to the surface, e.g. during use at higher temperatures. Such migration, generally referred to as blooming, can have negative effects on surface properties, like gloss, printability, etc., and also cause corrosion of metal parts. The possibility to apply high contrast markings, codes and the like by irradiation with a laser light source, for e.g. instruction and identification purposes or to distinguish from competitors, is an option that more and more becomes a requirement for such applications, and thus for polyester compositions. In order to comply with all these different requirements a polyester composition generally contains a series of additives, like flame-retardant compounds, anti-dripping agents, flow promoters, reinforcing agents, impact-modifiers, release agents, stabilizers, colorants, and laser-marking additives. A complicating factor is, that using the optimum additives regarding performance is often not in line with a yet unmentioned requirement, i.e. a low cost price.

Various publications deal with finding a proper balance between good processing behavior, mechanical, electrical and flammability properties and a low cost price for flame-retarded polyester compositions. In EP-A-0391731 a polyester composition is disclosed that contains a halogenated flame-retardant component, preferably a brominated aromatic compound, polytetrafluoroethylene (PTFE) as an anti-dripping agent, an auxiliary flame-retardant such as an antimony oxide, and optionally inorganic fillers and other additives. The composition is characterized in that a PTFE is used that is prepared via a suspension polymerization process. A polyester composition containing an aromatic polyester, poly(bromostyrene), antimony-compound and a hindered phenol compound is disclosed in JP-A-05140427. Herein it is described that the selected flame-retarder results in a composition with good mechanical properties, improved stability and reduced metal corrosion. Laser-marking was not addressed in these publications.

Polymer compositions comprising an antimony oxide are known in the art to be laser-markable. In DE-A-4143258, for example, a polyacetal composition comprising antimony trioxide is disclosed, which can be used to make an article on which a dark colored laser mark can be made. As suitable lasers are indicated excimer-lasers with a wavelength of between 200 and 550 nm, but not the more common Nd:YAG lasers operating at wavelength 1064 nm.

On moldings from a flame-retarded polyester composition, however, the distinctness of a mark, i.e. a sharp defined boundary between the mark and its background, may be insufficient for readily legible marking. Also, the use of special additives may be needed in order to enhance the contrast between the obtained marking and its background. This last issue has been encountered with a polyester composition comprising a bromine-containing compound, especially poly(bromostyrene). As is also indicated above, addition of extra additives is generally not favored, since they may induce undesirable changes in the delicate balance of overall properties profile and the cost price. It has also been observed that the contrast of a laser-mark obtained on a polyester composition of certain composition may vary for unexplained reasons.

Therefore, it is an object of the present invention to provide a flame-retarded polyester composition, which shows a combination of high strength and toughness, has good melt-flow characteristics, shows no blooming and which can be laser-marked with improved contrast using laserlight of wavelength in the 200-1064 nm range. It is another object to provide a molded part for use in electrical or electronic applications, which part may be provided with a dark marking on a lighter background surface. Other objects of the invention are to provide a process for applying a dark marking on a lighter background surface of an article at least partly made from a polyester composition, as well as an article carrying a dark laser mark on a lighter background surface for use in electrical or electronic applications.

### SUMMARY OF THE INVENTION

The present invention provides a flame-retarded laser-markable polyester composition comprising an antimony oxide of specified particle size as auxiliary flame-retardant compound and as laser-marking additive. Advantages thereof are that no special additives are needed for improving contrast of laser-marks and that other properties and the cost price are not affected. The invention more specifically relates to a flame-retarded laser-markable polyester composition comprising the following components:

(A) 20-95 mass % aromatic polyester;

(B) 4-25 mass % bromine-containing flame-retardant compound;

(C) 1-12 mass % antimony oxide of average particle size 0.5-15 micron;

(D) 0-5 mass % polytetrafluoroethylene;

(E) 0-45 mass % glass fibers;

(F) 0-30 mass % other additives;

wherein the sum of components (A)-(F) totals 100 mass %.

The invention also provides a molded part for use in electrical or electronic applications, wherein the part is molded from a polyester composition according to the invention, and wherein the part may be provided with a distinct, high contrast, dark marking on a lighter background surface.

The invention also provides a process for applying a dark marking on a lighter background surface of an article by irradiating the surface with laser light in the pattern of the marking, wherein the surface, at least at the place where the marking is applied, consists of a polyester composition according to the invention.

Use of the invention also provides an article for use in electrical or electronic applications comprising a part molded from a polyester composition according to the invention, which part carries a high contrast, dark laser mark on a lighter background surface. Other objects and advantages of the invention will be apparent to those of ordinary skill in the art.

### DETAILED DESCRIPTION OF THE PREFERRED EMBODIMENTS

The invention provides a flame-retarded laser-markable polyester composition comprising following components:

(A) 20-95 mass % thermoplastic aromatic polyester;

(B) 4-25 mass % bromine-containing flame-retardant compound;

(C) 1-12 mass % antimony oxide of average particle size 0.5-15 micron;

(D) 0-5 mass % polytetrafluoroethylene;

(E) 0-45 mass % glass fibers;

(F) 0-30 mass % other additives;

and wherein the sum of components (A)-(F) totals 100 mass %.

Within the context of this application the term antimony oxide is meant to include antimony-compounds like antimony trioxide, antimony pentaoxide, antimonates like sodium antimonate, hydrates of these compounds, and the like.

The polyester composition according to the invention can be marked by means of laser light forming a dark mark with a good contrast with its lighter background. A major advantage is that the wavelength of the laser light used for marking can be chosen within wide limits and is not limited to laser light from an excimer-laser with a wavelength of between 200 and 550 nm. In particular it is an advantage that the polyester composition can be marked with laser light of wavelength 1064 nm, enabling use of a readily available and more economic Nd:YAG laser.

A further major advantage of the polyester composition according to the invention is that it is possible to use a diode-pumped laser as well as a lamp-pumped laser to obtain markings having a good contrast.

In view of obtaining improved contrast the average particle size of the antimony oxide is preferably at least 1, more preferably at least 1.5, even more preferably at least 2 and most preferably at least 3 micrometer. With average particle size is meant the average particle diameter. This can be determined for example with a dynamic light scattering particle analyzer or sieve analysis, e.g. the 325-sieve residue method. Although the contrast can be further improved at higher diameters, the particle size is, in view of the retention of mechanical properties, preferably below 10, more preferably below 8 and most preferably below 6 micrometer. In a preferred embodiment of the composition according to the invention the antimony oxide has a particle size between 1 and 10 micrometer, more preferably between 2 and 8 micrometer and most preferred between 3 and 6 micrometer.

The amount of antimony oxide (C) in the polyester composition according to the invention is preferably at least 1.5 mass %, more preferably at least 2 mass %, and even more preferably at least 2.5 mass %. The advantage of this is an increasing improvement of the contrast, and better flame-retardant behavior. At higher contents up to for example above 10% the contrast may only marginally improve. Preferably, however, the amount of antimony oxide is lower than 10 mass %, more preferably lower than 8 mass %, and most preferably lower than 6 mass % as this results in better mechanical and electrical properties of the polymer composition, while the contrast obtained upon laser marking is not substantially less. A lower amount of antimony oxide will also reduce the density of the composition, and thus the cost-price per volume. Preferably, the polyester composition therefore contains between 1.5 and 10 mass %, more preferably between 2 and 8 mass % and most preferably between 2.5 and 6 mass % antimony oxide.

In U.S. Pat. No. 3,898,194 a polyamide composition is disclosed that contains 0.5-8 mass % of antimony trioxide of particle size between 1 and 10 micrometer, preferably between 2 and 2.5 micrometer, but this is only to improve mechanical and flammability properties. The publication EP-A-0472935 teaches to use antimony trioxide of particle size of 3 micrometer or larger to improve the light-resistance of a flame retarded styrene resin composition.

In general the particle size distribution of the antimony oxide will be normal and small. Hence the average of the particle size distribution (APS) is representative and normally used and reported in a suppliers specification of the antimony trioxide. However where the particle size distribution is not normal, for example when the distribution is very broad, skewed or bimodal for example due to the use of a mixture of batches having different particle size distributions, the average is not representative anymore and the main claim would relate to a polyester composition comprising 1-12 mass % antimony oxide containing at least 50 mass % of particles with a particle size of at least 0.5 micrometer, more preferably at least 1, more preferably at least 1.5 and most preferably at least 2 micrometer.

In a preferred embodiment the polyester composition according to the invention contains antimony trioxide as the antimony oxide. The thermoplastic aromatic polyester (component A) in the polyester composition according to the invention is generally derived from at least one aromatic dicarboxylic acid or an ester thereof and at least one (cyclo)aliphatic or aromatic diol, and includes homo- as well as copolymers. Examples of suitable aromatic diacids include terephthalic acid, isophthalic acid, naphthalene dicarboxylic acid, biphenyl dicarboxylic acid, etc., with terephthalic acid being preferred. Suitable diols include for example alkylene diols, hydroquinone, dihydroxyphenyl, naphthalenediol, or long chain diols like polyalkyleneoxide diols or aliphatic polyester dials. Alkylene diols, like ethylene diol, propylene diol, butylene diol and cyclohexane dimethanol are preferred. Such polyesters and their preparation are for example described in ‘Encyclopedia of polymer science and technology’, Vol. 12, John Wiley &Sons, New York, 1988 (ISBN 0-471-80944-6).

In a preferred embodiment the thermoplastic aromatic polyester is a polyalkyleneterephthalate, like polyethyleneterephthalate (PET), polybutyleneterephthalate (PBT), polypropyleneterephthalate (PPT), polycyclohexaneterephthalete (PCT), or copolymers thereof with a minority content of another dicarboxylic acid or diol. Also blends of different types or grades of polyalkyleneterephthalates can be used. These polyesters are very suited for use in molding compositions, especially in injection-molding compositions.

In a special embodiment according to the invention a polybutyleneterephthalate is used as the aromatic polyester. Advantages thereof include easy processing during compounding and injection-molding. The relatively low processing temperatures of PBT allow a broader choice of additives, and help to prevent excessive degradation. The composition may also contain another polyester, e.g. PET in minority content. Such a polyester blend has advantages regarding processing, and results in molded parts with better surface appearance.

Specifically preferred is the use of polybutyleneterephthalate with a relative solution viscosity of 1.7-2.0 (as measured on a 1 mass % solution in m-cresol at 25° C.). The advantage thereof is improved melt-flow behavior of the polyester composition, without unacceptable lowering of mechanical properties, which could be expected when using a polymer of relatively low molar mass.

As a bromine-containing flame-retardant compound (component B) any brominated organic compound may be used in the polyester composition according to the invention. Brominated aromatic compounds are preferred, however, for their better stability. Suitable examples include low molar mass brominated compounds, such as ethylene bistetrabromophtalimide, pentabromobenzylacrylate, ethylene bispentabromophenyl, tetrabromobisphenol-A, and bromine-containing oligomers or polymers, like a polycarbonate from brominated bisphenol-A, brominated polystyrene, or poly(bromostyrene). Preferred are those compounds that show good thermal stability, and that are not suspect of producing dioxins at high temperatures, including for example ethylene bistetrabromophtalimide, pentabromobenzyiacrylate, or poly(bromostyrene).

In a specially preferred embodiment of the invention the bromine-containing flame-retardant compound is a poly(bromostyrene) (PBS). PBS differs from brominated polystyrene in that it is produced by polymerizing brominated styrene monomer, and not by brominating polystyrene. In addition to its favorable stability, preventing e.g. blooming effects and corrosion of contacted metals, the use of this compound also results in improved melt-flow behavior of the polyester composition. A high molar mass of PBS results in a polyester composition with improved mechanical properties, whereas the lower the molar mass the better the melt-flow. Therefore, the poly(bromostyrene) preferably has a weight averaged molar mass (M_{w}) of 20.000-100.000 g/mol. In general, the higher the bromine content of the compound the less flame-retardant additive is needed to obtain the desired flammability behavior of the polyester composition. This is of advantage for other properties like toughness. Thus, in a preferred embodiment the poly(bromostyrene) has a bromine content of 61-65 mass %.

The content of the bromine-containing flame-retardant compound is preferably not higher than needed for fulfilling the flammability requirement. The needed amount will not only be dependent on the type of polyester in the polyester composition, but also on the other components present and their concentrations, like the antimony oxide and glass fibers. Preferably the content of bromine-containing flame-retardant compound is 6-20, more preferably 8-15 mass %.

During evaluation of flammability behavior according to the UL-94 test, dripping of molten polyester composition during flaming may prevent a V-0 classification. For this purpose up to 5 mass % of polytetrafluoroethylene (PTFE) may be added as anti-dripping agent to a flame-retarded composition. Preferably the PTFE content in the polyester composition is 0.25-2 mass %. The advantage is a good balance of flammability and other properties. In addition, it was found that upon adding PTFE the amount of flame-retardant additives, e.g. PBS and antimony trioxide, can be lowered without deteriorating flammability behavior. PTFE appears to acts as a synergistic agent. This not only is beneficial for mechanical properties, it also reduces the relative density of the composition and makes it more economic.

In a preferred embodiment of the invention the composition contains glass fibers (component E) as reinforcing agent. In order to obtain a polyester composition with desirable combinations of strength, stiffness, elongation at break and impact resistance values, the glass fiber content is preferably 10-40 mass %, and more preferably 15-30 mass %. Suitable glass fibers generally have a fiber diameter of about 5-20 micron, preferably about 10-15 micron, and comprise a sizing suited for polyesters.

In a special embodiment of the invention the polyester composition comprises

(A) 25-81.25 mass % polybutyleneterephthalate;

(B) 6-20 mass % poly(bromostyrene);

(C) 2.5-6 mass % antimony trioxide of average particle size 0.5-15 micron;

(D) 0.25-2 mass % polytetrafluoroethylene;

(E) 10-40 mass % glass fibers;

(F) 0-30 mass % other additives;

and wherein the sum of components (A)-(F) totals 100 mass %.

The polyester composition according to the invention can also contain one or more of the usual additives (component F), such as for example inorganic fillers, impact-modifiers, plasticisers, processing aids, stabilizers, CTI improving agents, dispersing aids, colorants, etc. Examples of suitable inorganic fillers include glass beads. (calcined) clay, mica, talc, kaolin, wollastonite, etc. As impact-modifier generally rubbery materials are used, preferably consisting or comprising functionalized copolymers that are reactive towards a polyester. Suitable examples include styrenic, olefinic or (meth)acrylic copolymers with acid, acidanhydride-, or epoxy functional groups, like a copolymer of ethylene, methylmethacrylate and glycidyl methacrylate or a maleicanhydride-functionalized copolymer of ethylene and propylene. Processing aids include e.g. mold-release agents, lubricants, and flowpromoters. Stabilizers for example include thermo-oxidative stabilizers like hindered phenolic compounds, hydrolysis stabilizers, such as acid scavengers like carbodiimides and epoxy compounds, and UV-stabilizers. A polar polymers like polyolefines, and inert fillers like bariumsulphate may be added to improve the CTI value (comparative tracking index) of the composition.

The polyester composition according to the invention may also contain colorants like inorganic pigments and organic pigments or dyes. The type of colorant and its amount is chosen so that it does not deteriorate other properties. Preferably, the color of the composition is not very dark or black, in order to allow a dark laser mark to be made, that is visible in contrast with a lighter background color. Most preferred are relatively light colors, like (off-)white, beige, or gray, like the light-gray color RAL 7035, which is frequently used in E&E applications.

The polyester composition according to the invention can be prepared in any customary manner by blending the various components in a suitable mixing device. Preferred devices are extruders, especially twin-screw extruders.

The invention also relates to a molded part for use in electrical or electronic applications, wherein the part is molded from a polyester composition according to the invention, and wherein the part may be provided with a dark marking on a lighter background surface. Preferably such a part is made via injection molding techniques.

The invention also provides a process for applying a dark marking on a lighter background surface of an article by irradiating the surface with laser light in the pattern of the marking, wherein the surface, at least at the place where the marking is applied, consists of a polyester composition according to the invention. Various lasers are suited for this purpose, but preferably a Nd:YAG laser is used, The advantage of such a laser is that it is stable and can be used in a writing mode. Both lamp-pumped and diode-pumped Nd:YAG lasers can be used. This is advantageous regarding availability and price level. Good results have been obtained with an apparatus producing a laser light beam of wavelength 1064 nm. Also with wavelengths of 532 and 355 nm, which are obtained with a Nd:YAG laser with frequency doubling, resp, tripling markings can be made on the surface of the compositions according to the invention.

The invention also provides an article for use in electrical or electronic applications comprising a part molded from a polyester composition according to the invention, which part carries a dark laser mark on a lighter background surface.

The invention will now be further illustrated by means of the following examples and comparative experiments, without being limited thereto.

Materials Used:

Component (A):

PBT 5015 (DSM Engineering Plastics, NL); a PBT base-polymer with relative solution viscosity 1.85 (as measured on 1 mass % solution in m-cresol at 25° C., based on ISO 307);

PET (DSM Engineering Plastics, NL); a PET base-polymer with relative solution viscosity 1.60.

Component (B):

PBS 64HW (Great Lakes, USA); a poly(bromostyrene) with 64 mass % bromine-content, M_{w} 60.000 g/mol;

Saytex® BT-93W (Albemarle); ethylene bistetrabromophthalimide;

Component (C):

Bluestar® RG (Campine, BE); used as 80 mass % antimony trioxide concentrate in PBT, average particle size 1.1 micron (Fisher number, suppliers specification);

Bluestar® Z (Campine, BR); antimony trioxide with particle size range 8-13 micron (suppliers information);

Trimonox® RT (Great Lakes, USA); antimony trioxide with particle size range 2-12 micron (suppliers information);

Trutint® 50(Great Lakes, USA); antimony trioxide with average particle size 3 micron (suppliers information);

Component (D):

Hostaflon® TF1645 (Dyneon. DE); a PTFE with average particle size of 220 micron.

Component (E):

Glass fibers; commercially available chopped strand glass fibers with sizing suited for polyesters; fiber diameter 11 micron, cut length 4.5 mm;

Component (F):

OE5860 (Borealis); ethylene/ethylacrylate copolymer;

Release agent; a standard agent based on fatty acid derivatives.

Processing:

Compositions were prepared on a W&P ZSK 30/34 twin-screw extruder. Barrel temperature was set at 260° C., throughput was about 10 kg/h, and screw-speed 200 rpm. Components were dosed to the hopper, separately or as a pre-blend, except glass fibers, which were dosed downstream onto the melt. Vacuum degassing was used (−0.9 bar). Extruded strands were cooled in water and granulated.

Test specimen were injection molded from dry granulates on an Engel 80A machine, with temperature settings 230-245° C., and mould temperature of 85° C. Standard test bars were made in accordance with UL-94, ISO 527, or ISO 179. Melt flow was evaluated with a mould containing a spiral channel of 1 mm thickness at injection pressures 720 or 1440 bar. Compositions are collected in Table 1.

Evaluation:

Flammability behavior was tested according to the UL-94 vertical burning test, using test bars of 0.8 mm thickness. Samples were conditioned at 23° C., 50% RH for 48 hours prior to testing.

Tensile properties were measured according to ISO 527/1. Charpy impact was tested according to ISO 179-1 E-A/U (notched and unnotched).

Laser marking is performed with a lamp-pumped Nd:YAG laser (Haas. DE) with wavelength 1064 nm; or with a diode-pumped Nd:YAG laser (Haas, DE) operating at wavelength 532 nm. Marks obtained are evaluated visually on legibility and contrast. The colors of the markings on the off-white background are from light gray (little contrast), gray/brown (good contrast), to dark gray/black (excellent contrast). In Table 2 contrast is indicated as (−) meaning no or insufficient contrast, (o) for acceptable contrast (legible), (+) for high contrast, and (++) for excellent contrast (easy legible from a distance).

Results are collected in Table 2.

TABLE 1

| | | | experiment | | | | | | | |
|---|---|---|---|---|---|---|---|---|---|---|
| composition | | Units | 1 | 2 | 3 | 4 | 5 | 6 | 7 | 8 |
| (A) | PBT 5015 | Mass % | 61.25 | 36.2 | 36.8 | 54.2 | 53.7 | 54.2 | 54.2 | 54.2 |
| | PET | Mass % | | 17.5 | 17.9 | | | | | |
| (B) | PBS 64HW | Mass % | 12.5 | | | 11.2 | 13 | 11.2 | 11.2 | 11.2 |
| | BT-93W | Mass % | | 12 | 10 | | | | | |
| (C) | Blue | Mass % | 5 | 4 | 4 | 3.3 | 3 | | | |
| | star RG | | | | | | | | | |
| | Bluestar Z | Mass % | | | | | | 3.3 | | |
| | Trionox RT | Mass % | | | | | | | 3.3 | |
| | Trutint 50 | Mass % | | | | | | | | 3.3 |
| (D) | TF 1645 | Mass % | 1 | | 1 | 1 | | 1 | 1 | 1 |
| (E) | glass fibers | Mass % | 15 | 30 | 30 | 30 | 30 | 30 | 30 | 30 |
| (F) | release agent | Mass % | 0.25 | 0.3 | 0.3 | 0.3 | 0.3 | 0.3 | 0.3 | 0.3 |
| | EEA | | 5 | | | | | | | |

TABLE 2

| | | experiment | | | | | | | |
|---|---|---|---|---|---|---|---|---|---|
| | units | 1 | 2 | 3 | 4 | 5 | 6 | 7 | 8 |
| flammability properties | | | | | | | | | |
| UL-94 (0.8 mm; 48 h/23° C.) | class | V-0 | V-0 | V-0 | V-0 | V-2 | V-0 | V-0 | V-0 |
| V-0 results | % | 100 | 100 | 100 | 100 | 60 | 100 | 100 | 100 |
| mechanical properties | | | | | | | | | |
| tensile modulus | GPa | 6.5 | 11.9 | 11.6 | 11.4 | 11.3 | | | |
| elongation at break | % | 3.1 | 1.71 | 1.62 | 2.1 | 2.2 | | | |
| tensile strength | MPa | 88 | 126 | 120 | 129 | 133 | | | |
| charpy impact (notched) | kJ/m² | 5.7 | 7.1 | 6.6 | 7.3 | 7.3 | | | |
| charpy impact (unnotched) | kJ/m³ | 47 | 48 | 45 | 51.2 | 50.6 | | | |
| other properties | | | | | | | | | |
| Laser markability at 1064 nm | | (++) | (+) | (+) | (+) | (+) | (++) | (++) | (+) |
| laser markability at 532 nm | | (+) | (o) | (o) | (o) | (o) | (+) | (+) | (+) |

What claimed is:

1. A flame-retarded laser-markable polyester composition comprising following components:
(A) 20-95 mass % thermoplastic aromatic polyester;
(B) 4-25 mass % bromine-containing flame-retardant compound;
(C) 1-12 mass % antimony oxide of average particle size 0.5-15 micron;
(D) 0-5 mass % polytetrafluoroethylene;
(E) 045 mass % glass fibers;
(F) 0-30 mass % other additives;
and wherein the sum of components (A)-(F) totals 100 mass %.

2. The polyester composition according to claim 1, wherein the antimony oxide is antimony trioxide.

3. The polyester composition according to claim 1 or 2, wherein the antimony trioxide has average particle size of 1-10 micron.

4. The polyester composition according to claim 1 or 2, wherein the antimony trioxide has average particle size of 2-8 micron.

5. The polyester composition according to claim 1 or 2, wherein the antimony oxide content is 2.5-6 mass %

6. The polyester composition according to claim 1, wherein the thermoplastic aromatic polyester is a polyalkyleneterephthalate.

7. The polyester composition according to claim 6, wherein the polyalkyleneterephthalate is polybutyleneterephthalate.

8. The polyester composition according to claim 1, wherein the brominated flame-retardant compound is a poly(bromostryrene).

9. The polyester composition according to claim 8, wherein the poly(bromostyrene) has a bromine content of 61-65 mass %.

10. The polyester composition according to claim 1, wherein the polytetrafluoroethylene content is 0.25-2 mass %.

11. The polyester composition according to claim 1, wherein the glass fiber content is 1040 mass %.

12. The polyester composition according to claim 1, wherein the glass fiber content is 15-30 mass %.

13. A flame-retarded laser-markable polyester composition comprising following components:
(A) 25-81.25 mass % polybutyleneterephthalate;
(B) 6-20 mass % poly(bromostyrene);
(C) 2.5-6 mass % antimony trioxide of average particle size 0.5-15 micron;
(D) 0.25-2 mass % polytetrafluoroethylene;
(E) 10-40 mass % glass fibers;
(F) 0-30 mass % other additives;
and wherein the sum of components (A)-(F) totals 100 mass %.

14. The polyester composition according to claim 13, wherein the antimony trioxide has average particle size of 1-10 micron.

15. The polyester composition according to claim 13, wherein the antimony trioxide has average particle size of 2-8 micron.

16. The polyester composition according to claim 13, wherein the poly(bromostyrene) has a bromine content of 61-65 mass %.

17. The polyester composition according to claim 13, wherein the glass fiber content is 15-30 mass %.

18. A molded part for use in electrical or electronic applications, wherein the part is molded from a polyester composition according to claim 1 or 13, and wherein the part may be provided with a dark marking on a lighter background surface.

19. A process for applying a dark marking on a lighter background surface of an article by irradiating the surface with laser light in the pattern of the marking, wherein the surface, at least at the place where the marking is applied, consists of a polyester composition according to claim 1 or 13.

20. The process according to claim 19, wherein the surface is irradiated with laser light of wavelength 1064 nm.

21. An article for use in electrical or electronic applications comprising a part molded from a polyester composition according to claim 1 or 13, which part carries a dark laser mark on a lighter background surface.
